(19) United States
(12) Patent Application Publication
(10) Pub. No.: US 2012/0007507 A1
(43) Pub. Date: Jan. 12, 2012

(54) METHOD AND SENSOR ARRANGEMENT FOR DETECTING THE VISIBILITY OUTSIDE OF A MOTOR VEHICLE

(75) Inventors: Thomas Niemann, Delmenhorst (DE); Olaf Lüdtke, Vollersode (DE); Almut Schlarmann, Bremen (DE); Jürgen Palloks, Westerstede (DE); Antje Müller, Lilienthal (DE); Tim Petasch, Bremen (DE)

(73) Assignee: Hella KGaA Hueck & Co., Lippstadt (DE)

(21) Appl. No.: 13/172,523

(22) Filed: Jun. 29, 2011

(30) Foreign Application Priority Data
Jul. 8, 2010 (DE) 10 2010 026 564.0

(51) Int. Cl. B60Q 1/02

(52) U.S. Cl. 315/82

(57) ABSTRACT

The invention relates to a method for detecting the visibility outside of a motor vehicle by means of at least two light sensors, in the case of which the intensity of the light reflection of the driving light emitted in the direction of travel is detected by means of a first light sensor, which is oriented in the direction of travel. The first light sensor thereby transmits at least a first evaluation signal to a control unit for further processing at least as a function of the recorded intensity of the light reflection. The ambient light is detected by means of a second light sensor and a second evaluation signal is transmitted to the control unit as a function of the intensity of the ambient light. The control unit correlates the evaluation signals of both light sensors and the light intensity threshold value is determined on the basis thereof. The control unit outputs different control signals in each case, in response the first evaluation signal is exceeding of falling below of the determined light intensity threshold value.

The invention relates to a method for detecting the visibility outside of a motor vehicle by means of at least two light sensors. The invention furthermore also relates to a sensor arrangement for a motor vehicle for detecting the visibility by means of at least one light sensor, which can be arranged so as to be oriented in the direction of travel.

Known methods and sensor arrangements are used, so as to detect the visibility, in particular outside of a motor vehicle, during the driving state, and to turn on the driving light, if necessary. The activation takes place, for example, when the vehicle drives into a longer, darkened road section or into a tunnel, in that the prevailing light conditions and thus the visibility are not sufficient for the driver of the vehicle to safely drive the motor vehicle through the tunnel.

For example, a sensor arrangement of the afore-mentioned species, which differentiates between shorter and longer darkened road sections and which controls the activation of the driving light as a function of the brightness value detected thereby in the direction of travel of the motor vehicle, is known from DE 196 30 216 C2. The driving light is thus turned on only when this is actually necessary. The brightness of the ambient light is furthermore detected with the help of such a sensor arrangement, which is already common in the state of the art, so that the driving light are turned on automatically below a predetermined threshold value, in particular in response to the onset of dawn. With reference to this, known sensor arrangements encompass at least one ambient light sensor and a light sensor, which is oriented in the direction of travel, wherein both sensors are coupled to a control unit, which is often embodied separately and which carries out an activation or a deactivation, respectively, of the driving light as a function of the signals, which are output by the light sensors.

Switching operations of the driving light, which are a function of ambient light, can be converted in a relatively problem-free manner by means of such sensor arrangements. However, visibility, which deteriorates during the day as well as during the night, for example caused by approaching fog, cannot be detected effectively by means of the known sensor arrangements. Changing visibility is thus detected exclusively by the driver of the vehicle, wherein said driver oftentimes takes corresponding measures, such as the reduction of the motor vehicle speed, much too late so as to avoid possible dangerous situations.

The invention is thus based on the object of creating a method and a sensor arrangement for detecting the visibility outside of a motor vehicle, by means of which abruptly changing visibility can also be detected easily and safely at the same time.

The solution of the object is carried out according to the invention by means of a method comprising the features of patent claim 1 and by means of a sensor arrangement comprising the features of patent claim 4. Advantageous further developments and embodiments of the invention are specified in the subclaims, which are in each case dependent on these claims.

Provision is made for a method according to the invention for detecting the visibility outside of a motor vehicle by means of at least two light sensors, in the case of which the intensity of the light reflection of the driving light, which is emitted in the direction of travel, is detected by means of a first light sensor, which is oriented in the direction of travel, the first light sensor transmits at least a first evaluation signal to a control unit for further processing at least as a function of the recorded intensity of the light reflection, the ambient light is detected by means of a second light sensor and a second evaluation signal is transmitted to the control unit as a function of the intensity of the ambient light, the control unit correlates the evaluation signals of both light sensors and the control unit determines a light intensity threshold value on the basis of the resulting ratios and the control unit outputs different control signals in each case, in response the first evaluation signal is exceeding or falling below of the determined light intensity threshold value.

Visibility, which may be limited by locally occurring ambient conditions, such as fog among others, can be detected advantageously by means of the method steps according to the invention. The reliable detection of possible limitations in the visibility additionally ensures an advantageous evaluation and a possible representation, so that a driver of a vehicle can always be informed of changing visibility immediately and can adapt the speed of the vehicle accordingly. The intensity of the light reflection of the driving light, which is substantially emitted forward in the direction of travel, which is detected by means of the light sensor, the reception area of which lies in particular in the visible area of the light, is a variable, which can be detected in an advantageous manner, as a function of the prevailing visibility. Typically, the more the visibility is limited, the greater the intensity of the light reflection of the artificial light source. An evaluation signal is then output to the control unit, based on the intensity, which is preferably detected continuously by the light sensor, wherein the control unit can output a control signal, in particular to an optical or acoustic signaling device, in the event that the evaluation signal reaches the level or size, respectively, of the predetermined threshold value of the light intensity, which is stored in the control unit, for example. The activated, thus turned-on driving light, which is in particular connected to the control unit so as to transmit a signal, is a condition for the conversion of the method according to the invention, so that the control unit can at least detect or query the switching state of the vehicle.

By simultaneously detecting the ambient light, the generally prevailing light conditions can additionally be evaluated in an advantageous manner; in particular, a differentiation between day and night can be made. An optimal adaptation, for example of the stored threshold value of the light intensity with reference to the degree of reflection of the visible radiation, which is emitted in the direction of travel and which also changes in response to varying ambient light conditions, is possible through this. In particular in the dark, a relatively small interference with visibility has a higher effect on the change of intensity of the light reflection, which can be detected by means of the light sensor, than interference with visibility during the day, which is comparatively stronger and which leads to a relatively small detectable change in the intensity of the light reflection. For the most part, large deviations or inaccuracies, respectively, of the signals, which are output in response to the detection of fog, and of the resulting evaluation relating to the visibility at hand, can be avoided through this.

The ratio of the evaluation signals, which are transmitted by the two light sensors, is preferably computed continuously, so as to optimally adapt the light intensity threshold value to the true conditions and to accordingly be able to ensure an advantageously accurate output of the control signals. The threshold value is thus always matched to the light and ambient conditions, which currently prevail, so that the control unit can advantageously consecutively output a plurality of control signals in response to a visibility, which is decreased to 100 meters, meters or 50 meters, for example, independent on external conditions. In addition to fog, rain or snow can also cause considerable interference with visibility, which can also be detected easily at any time with the help of the method steps according to the invention. The reliability with reference to the evaluation of the interference with visibility for a driver of a vehicle is thus further improved.

Preferably, for control signals, which are different or which can be differentiated from one another in each case, respectively, to be output by the control unit once the predetermined light intensity threshold value has been reached, in particular once it has been exceeded, and fallen below. An improved analysis of the detected evaluation signals is ensured by specifically differentiating between the exceeding of the threshold value, based on a detected light intensity value below the threshold value, and the falling below of the threshold value, based on a value thereabove. An optimal evaluation as to whether the interferences with visibility, which are caused by fog, for example, increase or decrease can then be carried out by means of the different control signals, which are output in this context. Due to the existing legal situation, this has the advantage, specifically in response to a rear fog light, which is used in response to visibility of below 50 meters, that specific notice can be given, for example, when the rear fog light must be turned on and when it is to be turned off again, respectively.

According to a development of the invention, the detection of virtually all of the relevant ambient conditions, which prevail inside or outside of the motor vehicle, is to be carried out so that a most comprehensive evaluation can be carried out with the help of the control unit and so that an advantageously accurate statement can be made relating to the interferences with visibility at hand. For this purpose, the humidity and the temperature are also measured in addition to the detection of the light reflection of the driving light by means of suitable sensors. An advantageously accurate adaptation of the light intensity threshold value is possible with the help of these additionally detected physical state variables.

According to a further development of the invention, provision is made for the control signal, which is output by the control unit, to be transmitted to at least one output device. In addition to or instead of an output of the control signal, parts of the driving light can also be controlled. A light control, which is a function of the driving situation, is thus converted, by means of which the low-beam light is not only activated automatically in response to a decreasing brightness of the ambient light or is deactivated in response to sufficient ambient light, respectively, but the fog light, if necessary, and possibly even the rear fog light can be turned on in response to visibility of less than 50 meters. In response to a change of the visibility with a visibility range of more than 50 meters, at least the rear fog light is then turned off again. At least the deactivation of the rear fog light, the operation of which in response to visibility of more than 50 meters represents a violation of the Highway Code, can thus advantageously be carried out automatically.

A sensor arrangement for a motor vehicle for detecting the visibility by means of at least one light sensor, which is oriented in the direction of travel, in particular for converting a method according to claims 1 to 3, wherein independent protection is requested for the sensor arrangement, is characterized according to the invention by a first light sensor, which detects the light reflection of the driving light and which can be coupled to the control unit so as to transmit a signal, wherein a first light sensor, which is oriented in particular in the direction of travel, is preferably embodied as a switchable diode, which detects radiations in at least two different wavelengths, and at least a second separate ambient light sensor, which detects the light energy available in the vicinity is furthermore assigned to the first light sensor.

The use of such a sensor arrangement, which is embodied according to the invention, represents an advantageously simple possibility for detecting the visibility, in particular during the driving state of a motor vehicle, with the help of which deteriorating visibility or decreasing visibility ranges, respectively, can always be detected reliably and relatively accurate evaluation signals for further processing are output as a function of the recorded values of the light reflection. For example, an evaluation unit or a control unit, respectively, which can be part of the sensor arrangement as well as a component of the assembly, which accommodates the sensor arrangement, can then convert the evaluation signals into measuring values, which can be evaluated directly. In particular the intensity of the driving light, which is emitted forward, in particular of the low-beam light, in a wavelength area of approximately 400 nm is detected by means of the first light sensor which is a sensor for visible light. The first light sensor can be coupled to the evaluation or control unit, respectively, in a wired or wireless manner, respectively, for the signal transmission of the evaluation signals.

The use of a suitable diode according to the invention as the first light sensor has the advantage that this diode can simultaneously be used for detecting visible light and for detecting infrared radiation. With reference to this, provision is made for the switchable diode or photodiode, respectively, to receive electromagnetic radiation with a wavelength of approximately 400 nm and in a range of approximately 800 nm. According to this, the diode in the sensor arrangement is used for the detection of the visibility as well as for a front end function for detecting darkened road sections, such as tunnels, for example. A constructively simplified embodiment of the sensor arrangement is attained by means of the functional double use of the light sensor, because two functions can advantageously be covered with only one sensor.

In addition to the first light sensor, which is oriented in the direction of travel, the second ambient light sensor detects the light energy available in the vicinity in an advantageously simple manner. Contrary to the first light sensor, which can be oriented in the direction of travel, the ambient light sensor encompasses a relatively wide detection cone, wherein the axis of the detection cone of the second ambient light sensor, in particular from the view of the driver, is oriented substantially upwards with a relatively small incline forward in the direction of travel. It is ensured through this that a representatively large area of the actually existing light ratios is detected by means of the second ambient light sensor. Preferably, the ambient light sensor encompasses a cone-shaped detection area comprising an obtuse opening angle between surface lines, which are located opposite one another.

At least one humidity sensor and at least one temperature sensor are furthermore assigned to the light sensors of the sensor arrangement. Through this, further ambient conditions or influences, respectively, can be detected advantageously by means of the sensor arrangement, which is embodied according to the invention. The arising or changing ambient conditions, respectively, which are output to a control unit by means of the sensors, can be analyzed fundamentally specifically by means of the monitoring of the temperature and of the humidity content in the air, so that an evaluation, which is always reliable, can be carried out by means of the evaluation or control unit, respectively.

Independent protection is also claimed for a motor vehicle comprising at least one sensor arrangement for detecting the visibility and comprising at least one control unit for controlling the driving light at the motor vehicle, wherein the sensor arrangement encompasses the features according to the invention in accordance with one of claim 4 or 5, and that at least one signaling device for an output signal is coupled to the control unit once a predetermined threshold value of the light reflection of the driving light has been reached. The sensor arrangement according to the invention operates in combination with a control unit, which is provided at the motor vehicle, which simultaneously carries out the light control at the vehicle, for example, preferably according to a method in accordance with one of claims 1 to 3. The signaling device coupled to the control unit can thereby be an optical and/or acoustic signaling device, by means of which an advantageous representation of the prevailing visibility is ensured upon reaching the light intensity threshold value, which is determined in particular in a continuous iterative manner, by means of the evaluation signal, which is output by the light sensor, which is oriented in the direction of travel. Likewise, it is also possible to carry out a direct activation or deactivation, respectively, of the auxiliary headlamps or of the rear fog light as a function of the detected visibility, instead of the control of a signaling device by means of the control unit.

A possibly exemplary embodiment of the invention, from which further inventive features result, is illustrated in the drawing.

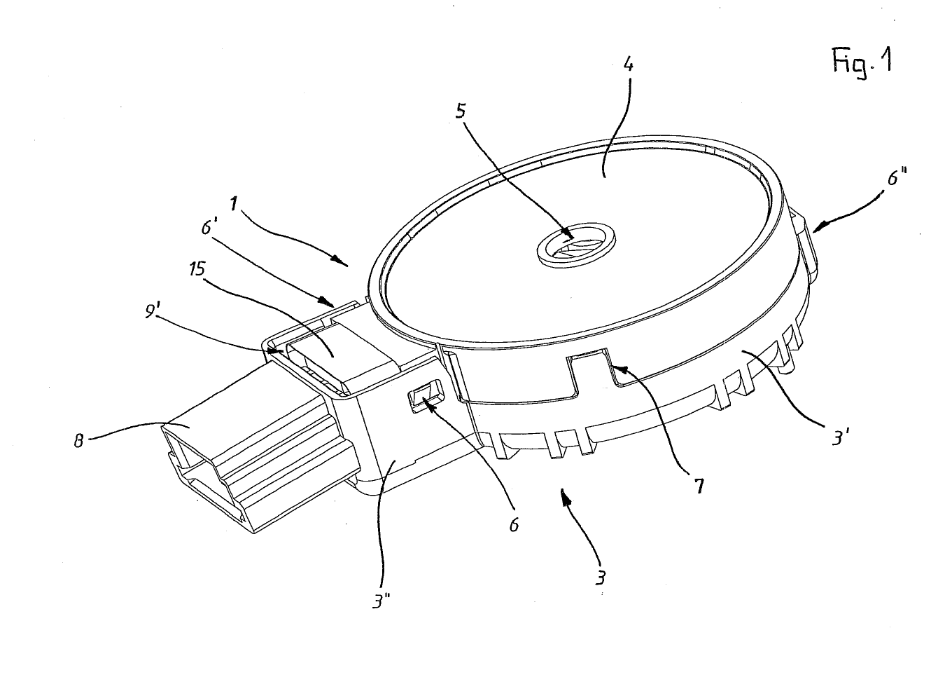

FIG. 1 shows a sensor arrangement comprising a closed housing in a perspective view;

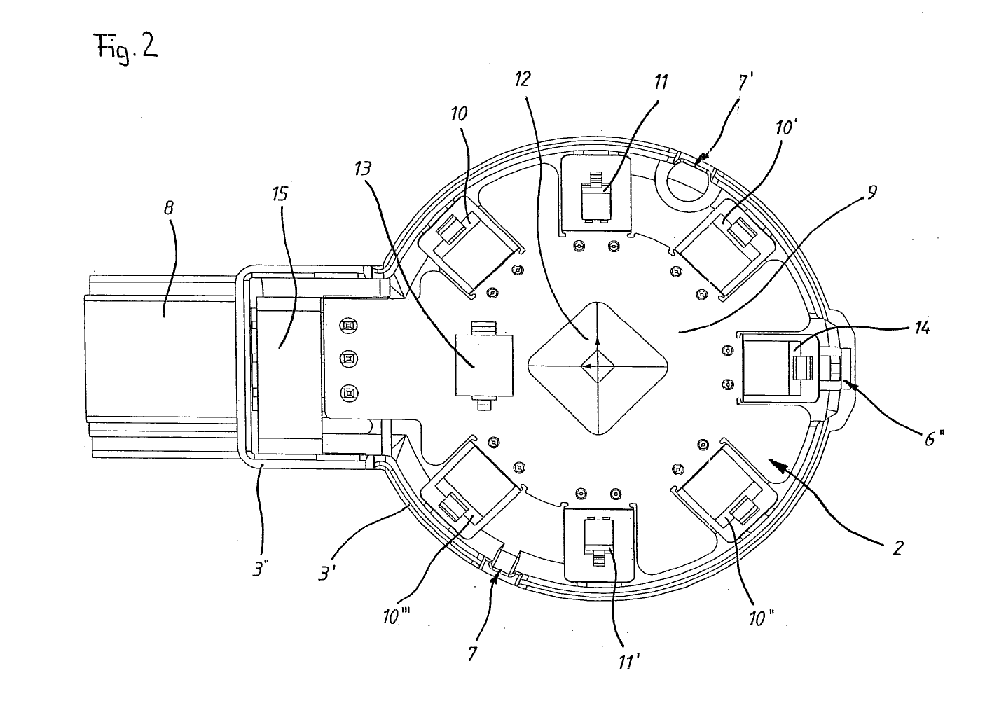

FIG. 2 shows the sensor arrangement in FIG. 1 comprising an open housing without a cover comprising an exposed printed circuit board in a top view and

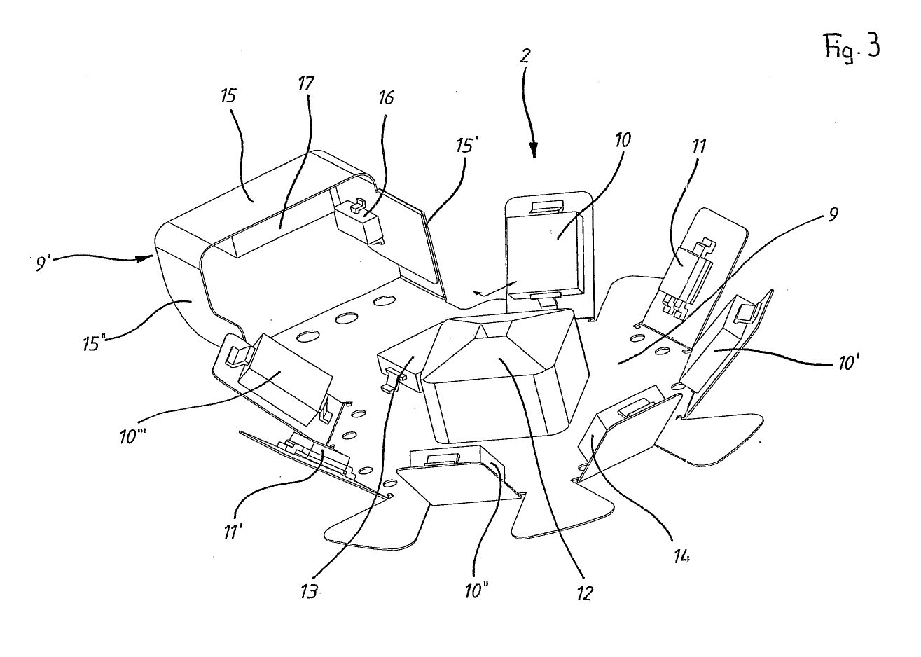

FIG. 3 shows the printed circuit board of the sensor arrangement in FIG. 1 and FIG. 2 in a perspective view comprising sensors, which are arranged on the printed circuit board.

A housing of a sensor arrangement 2 (FIG. 2) is shown by means of 1. This housing 1 encompasses an accommodating part 3 and a cover 4, which are connected to one another so as to be capable of being removed. The cover 4 is embodied in a substantially circular manner and encompasses an opening 5 in the center area of the embodied circle. The accommodating part 3 encompasses a first circular accommodating area 3′ and a second elongate connecting area 3″. To connect accommodating part 3 and cover 4, provision is made for three locking connections 6, 6′, 6″ and for two plug connections 7, 7′. The accommodating part 3 encompasses three locking elements of the locking connections 6, 6′, 6″, with two of said locking elements of the locking connections 6, 6′ being arranged on the elongate connecting area 3″ at the first end of the connecting area 3″, which is set against the accommodating area 3′, and a third locking element of the locking connection 6″ being arranged on the circular accommodating area 3′ at the side, which is located opposite to the elongate connecting area 3″. In addition, the accommodations of the two plug connections 7, 7′ are arranged at the outer periphery of the circular accommodating area 3′. The cover 4 encompasses locking lugs and plug elements, which correspond to the locking elements and accommodations.

The free second end of the elongate connecting area 3″ of the accommodating part 3 furthermore encompasses a plug connector 8 for data transmission and for fastening of the sensor arrangement 2.

In the interior of the housing 1, a printed circuit board 9, which continues with a connecting section 9′ in the elongate connecting area 3″ of the accommodating part 3, is arranged on the accommodating area 3′ of the accommodating part 3. A partial area of the connecting section 9′ projects beyond the housing 1 between the cover 4 and the plug connector 8. To hold the printed circuit board 9 in position on the accommodating part 3, the accommodating part 3 encompasses pins, which correspond to recesses in the printed circuit board 9.

The design of the printed circuit board 9 comprising the sensor arrangement 2 is illustrated in FIG. 2 and FIG. 3. The printed circuit board 9 is embodied in a circular manner and encompasses a diameter, which is slightly smaller than the inner diameter of the circular accommodating area 3′ of the accommodating part 3.

Around its center area, the circular printed circuit board encompasses a total of seven surfaces, which are set against the printed circuit board 9 at an angle and which encompass approximately the same distance to the center area. Optical elements are arranged on these surfaces.

Four of the seven optical elements on the set surfaces of the printed circuit board 9 are receiving diodes 10, 10′, 10″, 10′″, which receive infrared radiation, wherein the diodes around the center area of the printed circuit board are arranged so as to be offset to one another, in particular at an angle of 90°. In the center area, the printed circuit board 9 encompasses a rain sensor, to which the receiving diodes 10, 10′, 10″, 10′″ and a emitting unit 12 are assigned in a functional manner. The emitting unit 12 emits the infrared radiation, which is reflected on a windshield, for example, and which changes as a function of the wetting of the windshield with water and will then receive from the receiving diodes 10, 10′, 10″, 10′″. A solar sensor 11, 11′, by means of which the direction of the solar radiation can be detected, is in each case arranged on the two remaining opposite set surfaces of the printed circuit board 9.

An ambient light sensor 13, which detects the brightness in its detection area, is furthermore arranged on the printed circuit board 9 between the emitting unit 12 and the connecting area 3″ of the accommodating part 3. A front end light sensor 14 is arranged on the set surface, which is located on a straight line with the emitting unit 12 and the ambient light sensor 13. On the one hand, this front end light sensor 14, which is embodied as switchable photodiode and which thus detects radiation in at least two different spectral ranges, can detect the brightness in a predetermined distance to the sensor arrangement 2 and, on the other hand, a reflecting light signal. The opening angle of the detection cone of the sensors is predetermined in particular by the dimensions of the opening 5 in the cover 4 and by the position or the arrangement, respectively, of the respective light sensor 13, 14 to the opening 5.

The connecting section 9′ is angled several times, in each case by 90°, and projects between the cover 4 and the plug connector 8, which embodies the partial area of the printed circuit board 9, which is visible in FIG. 1 through an opening comprising a contact surface 15. Two surfaces 15′, 15″ of the connecting section 9′, which are arranged at a right angle to the contact surface 15 and to the printed circuit board 9, are set against the contact surface 15, whereby the surface 15′ connects the contact surface 15 to the printed circuit board 9. The embodiment of the connecting section 9′ becomes clear in particular in FIG. 3, wherein the two surfaces 15′, 15″ are arranged parallel to the inner wall of the elongate connecting area 3″ of the accommodating part 3.

A temperature sensor 16 for detecting the room or air temperature, respectively, and a combined humidity and temperature sensor 17 are arranged on the inner sides of the surfaces of the connecting section 9′ for detecting a surface temperature as well as the room or air humidity, respectively. The combined temperature and humidity sensor is thereby arranged on the contact surface 15, which projects from the housing 1, while the temperature sensor 16 is arranged on the surface 15′ of the connecting section 9′, which is embodied at right angles to the printed circuit board 9, for detecting the room or air temperature, respectively.

This embodiment of the sensor arrangement 2 is arranged on the inner side of the windshield of a vehicle, wherein the side comprising the cover 4 faces the windshield of the vehicle and the elongate connecting area 3″ of the accommodating part 3 is oriented in the direction of travel. The detection area of the front end light sensor 14 thus encompasses a detection cone, which is oriented substantially in the direction of travel of the vehicle, while the ambient light sensor 13 encompasses a detection area comprising a detection cone, which is oriented substantially upwards. For example, a driving light control, which is adapted to the respective driving situation of the vehicle, can be converted by means of the data, which are determined by the ambient light sensor 13 and the front end light sensor 14. A detection of ambient conditions, such as fog, snow or the like, which impact the visibility, is also possible.

1. A method for detecting the visibility outside of a motor vehicle by means of at least two light sensors, in the case of which the intensity of the light reflection of the driving light emitted in the direction of travel is detected by means of a first light sensor, which is oriented in the direction of travel,
the first light sensor transmits at least a first evaluation signal to a control unit for further processing at least as a function of the recorded intensity of the light reflection,
the ambient light is detected by means of a second light sensor (13) and a second evaluation signal is transmitted to the control unit as a function of the intensity of the ambient light,
the control unit correlates the evaluation signals of both light sensors and a light intensity threshold value is determined on the basis thereof, and
the control unit outputs different control signals in each case, in response the first evaluation signal is exceeding or falling below of the determined light intensity threshold value.

2. The method according to claim 1, wherein the humidity and the temperature are measured simultaneously in addition to the detection of the light reflection of the driving light.

3. The method according to claim 1, wherein the output control signal is transmitted to at least one output device.

4. A sensor arrangement for a motor vehicle for detecting the visibility by means of at least a first light sensor, which can be arranged so as to be oriented in the direction of travel, wherein:
the light first sensor is embodied such that the intensity of the light reflection of the driving light, which is emitted in the direction of travel, can be detected, wherein the light sensor can be coupled to a control unit so as to transmit a signal,
the first light sensor is a switchable diode, which detects radiations in at least two different wavelengths, and
at least a second light sensor, which detects the ambient light.

5. The sensor arrangement according to claim 4 wherein at least one humidity sensor and at least one temperature sensor are additionally assigned to the light sensors.

6. A motor vehicle comprising at least one sensor arrangement for detecting the visibility and comprising at least one control unit for controlling the driving light at the motor vehicle, wherein:
the sensor arrangement is a sensor arrangement according to claim 4 and
at least one signaling device for an output signal is coupled to the control unit once a predetermined threshold value of the light reflection of the driving light has been reached.
